(19) United States
(12) Patent Application Publication
(10) Pub. No.: US 2009/0232457 A1
(43) Pub. Date: Sep. 17, 2009

(54) Splicer with Splicing Cassette Carrier

(75) Inventors: Thomas Detemple, München (DE); Heinz Kronawitter, Neuried (DE); Marco Forlenza, München (DE); Christian Heidler, Bad Kreuznach (DE); Martin Klahr, Aschau (DE); Rainer Kossat, Aschau (DE)

Correspondence Address: CORNING INCORPORATED, INTELLECTUAL PROPERTY DEPARTMENT, SP-TI-3-1, CORNING, NY, 14831, US

(73) Assignee: CCS TECHNOLOGY , INC.

(21) Appl. No.: 12/224,818

(22) PCT Filed: Mar. 1, 2007
(86) PCT No.: PCT/EP2007/001773

§ 371 Date: Feb. 4, 2009

(30) Foreign Application Priority Data
Mar. 8, 2006 (DE) 10 2006 010 753.5
Jul. 5, 2006 (DE) 10 2006 031 077.2

(51) Int. Cl. G02B 6/255; G02B 6/00

(52) U.S. Cl. 385/95; 385/134

(57) ABSTRACT

A splicer comprises a chassis with an opening in which a splicing unit for splicing of optical waveguides is arranged. The splicer can be controlled via a control and display apparatus. A splicing cassette carrier is arranged rotatably on the chassis. The splicing cassette carrier is designed such that it can be used both for fixing a splicing cassette or else as a carrying handle for the splicer. Furthermore, the splicer has a control unit via which the splicer is switched to an active operating mode or to a standby mode, as a function of the rotation position of the splicing cassette carrier. When the splicing cassette carrier is open, the light intensity of background lighting for the display apparatus and the light intensity of a lighting device can be controlled so they are variable. The reduced power consumption associated with this allows the operational readiness of the splicer to be lengthened.

### FIELD OF THE INVENTION

The invention relates to a splicer with a splicing cassette carrier for holding a splicing cassette while optical waveguides or optical fibers are being spliced in the splicer. The invention also relates to mobile or portable lightweight splicers, which can be transported and used by one operator, in order to splice optical fibers inside or outside closed buildings.

### TECHNICAL BACKGROUND

Splicers are used in a wide technical field, although they are particularly suitable for splicing optical waveguides and optical fibers. Mobile splicers are particularly suitable for use in the field, and are used when, for example, optical fibers are spliced on a mast or for an underground cable. A mobile splicer such as this typically comprises a splicing unit, a control and display unit, a shrinking unit and a chassis which accommodates these units. The splicer generally has an associated splicing cassette carrier, which is used to accommodate the splicing cassettes required for splicing. The fibers which have previously been spliced in the splicing unit are inserted into the splicing cassette in order to keep them clearly arranged during the time in which further fibers are being spliced. The splicing cassette normally comprises a plastic housing which can be opened, and holding apparatuses, incorporated therein, for the spliced fibers.

One example of a splicing unit is shown in FIG. 7. Two fiber strips which are to be joined together and have optical fibers 18 are each fixed shortly before their ends in fiber holders 16 and are positioned on movement units (X, Y and Z direction), which are not shown, in order to be spliced. The ends of the optical fibers 18 can be aligned with the aid of grooves into which the fibers are introduced. Assuming that the fibers are optimally positioned in the individual grooves, then the movement units then just need to be aligned. In an improved embodiment, detectors and light sources can also be used in order to adjust the fiber ends with respect to one another.

Once the two ends of the respective fibers 18 have been moved to a position close to one another, then a voltage is applied between the electrodes 14, which are held by electrode holders 12, and leads to a hot arc being formed. The respective fiber ends melt under the deliberate influence of heat.

The user of a splicer carries out a predetermined sequence of activities for splicing of optical fibers. The splicer is placed on a flat stable surface or base in order to carry out the splicing process. First of all, the sheaths on the exposed cable ends of the cable are removed, followed by removing the fiber coatings on the individual fibers which are contained in the cable. The unprotected ends of the individual fibers are inserted in the fiber holder 16. A splicing cassette 36 is also provided for the multiplicity of spliced individual fibers. A splicing cassette carrier on which the splicing cassette is positioned can optionally be provided for this purpose. A splicing cassette carrier such as this is in general either permanently fitted to the splicer, can be mounted on the splicer (screwed, hooked-in, etc.) or is simply placed alongside the splicer.

The two fiber holders 16 with the fixed ends of the optical fibers 18 are inserted into the splicing unit 10. The splicing unit 10 is located, in a protected manner, within the chassis, behind an opening which is provided with a cover in order to protect the fine mechanism. Once the splicer has been positioned, the splicing cassette carrier has been provided and the fiber end with the fiber holders has been prepared, then the splicer is operated via a control and/or display apparatus. The splicing process is controlled via a control area. A display area provides status messages relating to the adjustment and the splicing process itself. Once the splicing process has been completed, the spliced fiber strips are removed from the splicing unit 10, or the opening 30 in the chassis, and are passed to a shrinking unit. During this process, shrink sleeves are shrunk onto the spliced points of the fiber cable 18 under the influence of heat, in order to protect the cable.

The splicing cassette carrier is preferably located on the rear face of the splicer. This is because, the movement procedure can be carried out in this case, starting with the fibers being inserted into the splicing unit, through the shrinking process to the spliced fibers being placed in the splicing cassette in the direction of the rear face of the appliance. This is because, as seen by the operator, the splicing unit is aligned at the front on the splicer, while the shrinking unit is arranged behind it, and the splicing cassette carrier is located on the rear face of the appliance, as a result of which the fibers which have been placed down and spliced are no longer in the way of further splicing processes.

A splicer is subject to stringent requirements, particularly for use in the field, outside closed buildings. The development progress for the fine mechanism in the splicing unit has resulted, for example, in a requirement to ensure better protection against dirt and shaking. However, for ergonomic reasons, the appliance design must not become more cumbersome, and an increase in weight resulting from the additional protective measures should be avoided.

### SUMMARY

This problem as well as further problems which are only indicated here are solved by a splicing cassette carrier for holding a splicing cassette while splicing optical waveguides in a splicer, comprising: a plate with a flat surface for holding the splicing cassette; at least one carrier arm which is connected to the plate and supports it; and an apparatus in which the at least one carrier arm can be attached to a chassis of the splicer, mounted such that it can rotate about an axis, such that the splicing cassette carrier can be pivoted about the axis.

The problems are also solved by a splicer comprising a chassis with at least one opening and an apparatus for rotatable mounting of the splicing cassette carrier described above, a splicing unit for splicing of optical waveguides, with the splicing unit being arranged in the opening of the chassis, a control and/or display apparatus for controlling the splicing, which control and/or display apparatus is arranged in the chassis, and the splicing cassette carrier, which is mounted rotatably on the chassis by means of the apparatus, such that it can assume a first rotation position, in which it is used as intended to hold a splicing cassette, and at least one second rotation position, in which it acts as a protective cover for the control and/or display apparatus.

One of the ideas on which the invention is based is to attach the splicing cassette carrier to the chassis such that it can be used not only for its specific purpose for holding a splicing cassette during splicing but such that it can additionally also act as a cover for the control and/or display apparatus before or after the splicing process. This purpose is achieved by the splicing cassette carrier being mounted on the chassis such that it can rotate.

In consequence, the splicing cassette carrier can be moved from a first position, in which it can hold a splicing cassette, to a further position in which it covers the control and/or display apparatus. The splicing cassette carrier therefore carries out a dual function, in which it is additionally also used to protect system components of the splicer. Consequently, relatively sensitive components can also be used in the area of the control and/or display apparatus, such as TFT displays or finer keyboard elements which could not be provided in this form without effective protection against mechanical damage, dust, dirt, and the influence of cold or moisture. Furthermore, the cover provides protection against function keys in the control area being pressed inadvertently. A splicing cassette carrier such as this therefore allows considerable improvements to the splicer.

In addition, the dual use of the splicing cassette carrier both as a holder for the splicing cassette and as a cover for the control and/or display apparatus allows a considerable amount of weight to be saved because an additional cover is not required.

The configuration of the rotatable mounting is freely variable. For example, the shaft can be formed on the chassis and the relevant bush on the splicing cassette carrier. However, an opposite arrangement is likewise feasible. The invention likewise includes other options for mounting, such as attachment via an elastomeric compound, a ball bearing, electromechanical components, etc.

One refinement of the splicing cassette carrier provides for stop pins, which for example are removable, to be provided in the flat surface of the plate which holds the cassette. Depressions, in which the removable pins can be inserted, can be provided in the plate (or on the carrier arm) in an appropriate form, depending on the standard width of the splicing cassette.

The splicing cassette can be fixed on the stop pins by lateral opposing pressure. According to one refinement, a clamp can be provided for this purpose and is drawn, for example by a spring or other tension elements, in a direction parallel to the surface of the accommodating plate. The clamp thus presses the splicing cassette against the stop elements, as a result of which the splicing cassette is held securely on the splicing cassette carrier.

A further refinement provides for the clamp to be provided at the edge of the plate accommodating the splicing cassette, in which case it additionally also carries out the function of a closing apparatus for the splicing cassette carrier when the latter is in a position in which it covers the control and/or display apparatus. By way of example, a cover such as this can be unlocked by tightening the clamp in order then to fold it over such that the function of this cover can then be changed to that of the splicing cassette carrier.

A further refinement provides for the carrier arms to be designed such that they project beyond the plate which accommodates the splicers. This makes it possible to provide a cutout in the carrier, in which the cover which covers the opening in the chassis to the splicing unit comes to rest. The plate then pivots beyond the splicing and shrinking unit, which is positioned centrally on the chassis, between a carrier position (on the splicing rear face) and the covering position for the control and/or display apparatus (on the front face of the splicer), with these positions being at a distance from one another.

One particularly advantageous refinement also provides for the splicing cassette carrier to be used not only for its covering function but also additionally as a holder or handle for the splicer itself. The splicing cassette carrier can pivot freely between positions which can be marked, for example, by striking surfaces. The striking surfaces define the positions of the splicing cassette holder and the covering function. A rotation position which defines the handle function is located at an angular position in the middle but within this pivoting range.

In this refinement, an inner edge of the accommodating plate for the splicing cassette may have shaped elements which, for example, are matched to the shape of fingers of a hand which clasps this edge. Shaped elements such as these are made from material which is resistant to being gripped and may also be elastic.

A more advanced refinement provides for the center of gravity of the splicer to be designed such that it is located vertically below the axis of the splicing cassette carrier when the splicer is mounted or positioned flat on a surface. In this case, when the splicer is lifted with the aid of the handle, that is to say with the aid of the splicing cassette carrier, it is not possible for the splicer to carry out a sudden rotary movement relative to the splicing cassette carrier, which is held fixed.

The splicer can therefore be lifted and placed down safely without this resulting in severe shaking. One embodiment provides for preferred latching-in positions to be created by projections or tabs in the area of the axis or on the carrier arms thus making the splicer even more robust while being carried, and/or suppressing rotary movements of the splicer. Latching-in means such as these can also be used for the rotation positions in which the carrier and/or covering function is carried out by the splicing cassette carrier.

In one preferred embodiment of the splicer, the splicer comprises a control unit for controlling a splicing process, which control unit is connected to the control and/or display apparatus and to the splicing unit.

In one development of the splicer, the splicer has a supply device for providing a supply current for operating circuit components of the splicer. The splicer can be operated in a first or a second operating mode, with a lower supply current being provided by the supply device in the first operating mode than in the second operating mode. The control unit is designed such that it operates the splicer in the first or second operating mode as a function of the rotation position of the splicing cassette carrier.

By way of example, the first operating mode corresponds to a standby mode. The control unit operates the splicer in the standby mode, in which the power consumption is reduced, when the splicing cassette carrier is closed. This makes it possible to lengthen the operational readiness of the splicer.

However, it is also possible to reduce the current consumption when the splicing cassette carrier is open. For this purpose, the display apparatus has background lighting, the light intensity of which is variable. By way of example, a brightness sensor is provided in the control apparatus and detects the environmental brightness of the splicer when the splicing cassette carrier is open. The control unit operates the display apparatus such that the light intensity of the background lighting is set as a function of the environmental brightness detected by the brightness sensor. The power consumption of the display apparatus when the splicing cassette carrier is open can therefore be reduced in a bright environment.

### BRIEF DESCRIPTION OF THE FIGURES

The invention will now be explained in more detail with reference to figures, which show exemplary embodiments of the present invention, and in which:

FIG. 1 shows an illustration of the splicing cassette carrier, removed from the splicer, and an enlarged illustration of one of the carrier arms;

FIG. 2 shows a perspective view of a splicer according to one exemplary embodiment, with a splicing cassette carrier used as a cover;

FIG. 3 shows a perspective view of a splicer according to one exemplary embodiment, with a folded-up splicing cassette carrier used as a handle;

FIG. 4 shows a side view of the splicer shown in FIG. 3, in the form of a schematic illustration;

FIG. 5 shows a side view of the splicer according to one exemplary embodiment, in the form of a schematic illustration, with a folded-back splicing cassette carrier used as a cassette holder;

FIG. 6 shows an illustration of a splicer with an open covering apparatus;

FIG. 7 shows a schematic illustration of a splicing unit according to the prior art.

### DETAILED DESCRIPTION OF THE INVENTION

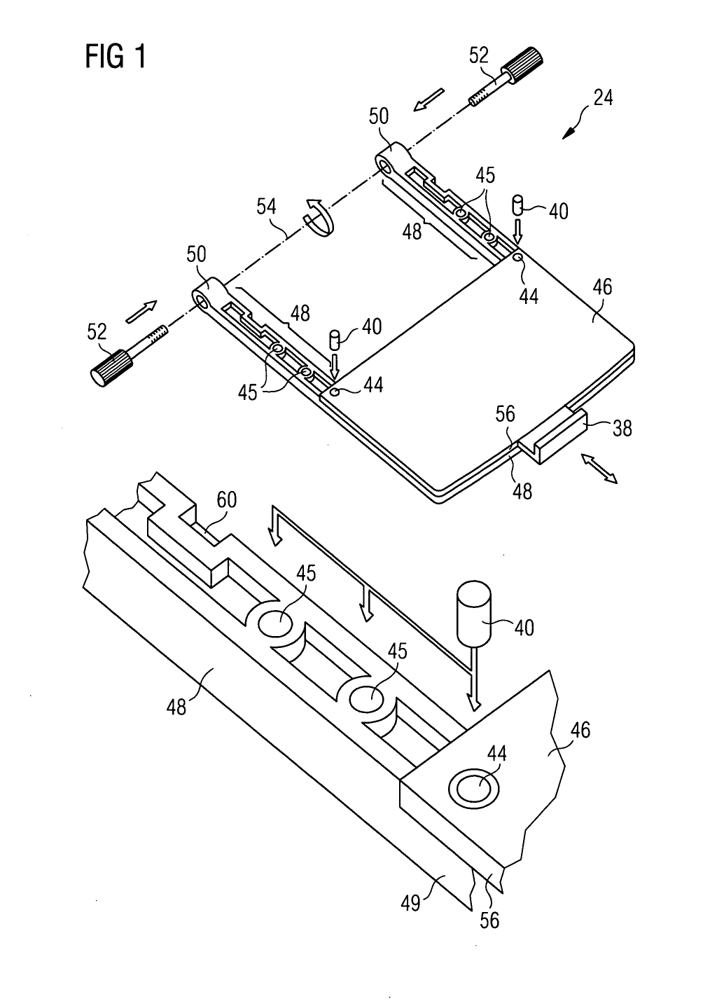

FIG. 1 shows a perspective illustration of a splicing cassette carrier 24 according to one exemplary embodiment of the invention. The splicing cassette carrier 24 can be seen in its entirety in the upper half of the figure, while the lower half of FIG. 1 shows an enlarged detail of the carrier arm 48.

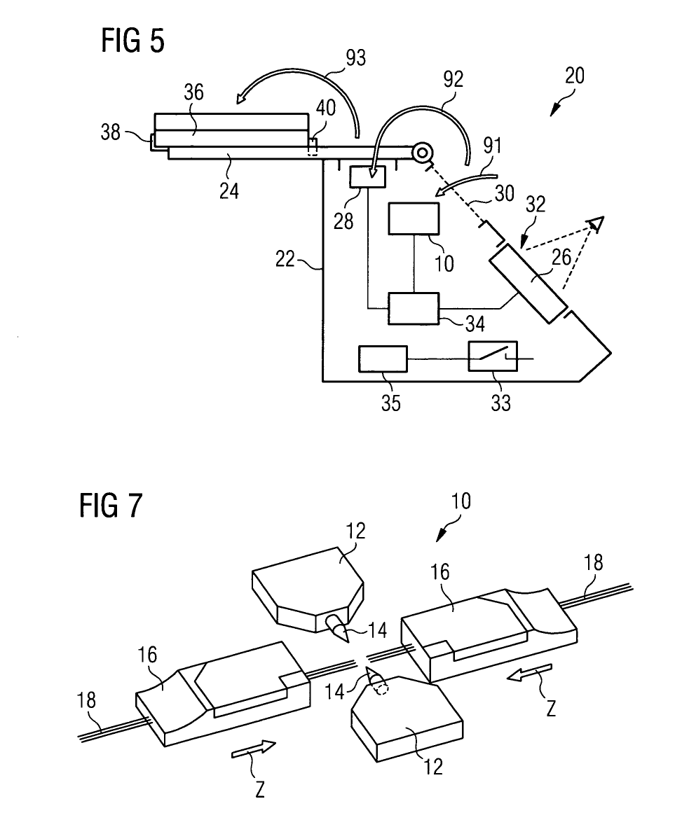

The splicing cassette carrier 24 comprises a plate 56 which has a flat surface 46 and may be made, for example, from metal or from plastic. The plate 56 is used to accommodate a splicing cassette 36 (see FIG. 5). The splicing cassette carrier 24 also has two carrier arms 48, which lengthen the flat surface 46 of the plate 56 beyond its edge. The carrier arms 48 have two functions. On the one hand, they make the plate 56 robust by also continuing as elements 49 underneath the plate 56 thus ensuring that the metal plate is in a stable position at a given rotation angle and preventing torsion, while on the other hand they connect the metal plate to bushes 50 which are part of a shaft mounting for the splicing cassette carrier 24 on the chassis 22 of the splicer 20. In this case, screws 52 are used to attach the splicing cassette carrier 24 to the chassis 22, mounted such that it can rotate, and to form a rotation axis 54, around which the splicing cassette carrier 24 can be rotated. The screws 52 allow the splicing cassette carrier 24 to be attached and detached easily.

Holes 44, 45 in which pins 40 can be inserted as stop elements for the splicing cassette 30 are provided in the plate 56 and on the carrier arms 48. With respect to an opposing element, which is provided by the clamp 38, the stop pins 40 make it possible to set three different widths for the splicing cassette 36, on the basis of the hole positions 44, 45. The clamp 38 is connected to a tension spring (not shown), which presses the clamp 38 against the fitted splicing cassette 36, such that the cassette is clamped in between the stop pins 40 and the clamp 38.

The plate 56 can be attached in any desired manner to the elements 49 and to the carrier arms 48, for example by screw connection, adhesive bonding, etc. Alternatively, the plate 56 can also be formed from the same material as the carrier arms 48, 49, and an integral embodiment is also feasible.

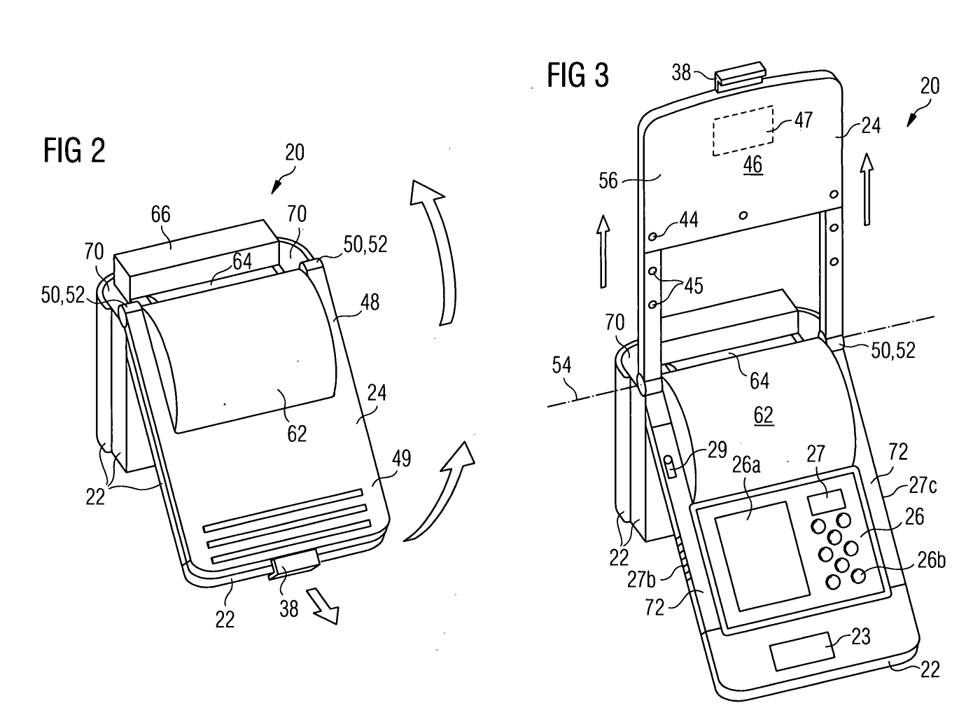

The element 49 may itself be in the form of a plate. As can be seen in FIG. 2, in order to prevent the hand from sliding off during pivoting, three structures like lines are structured on the surface of the element 49. In this exemplary embodiment, the carrier arms 48 and the element 49 are formed integrally from a plastic. Because, in its covering function, the element 49 at the same time also represents a surface of the splicer which can be seen, design elements can also be formed in, or inscriptions can be applied.

FIG. 2 shows a perspective illustration of a splicer 20 according to one exemplary embodiment. The illustrated situation shows the splicer 20 with the cover or splicing cassette carrier 24 folded closed. The clamp 38 can in this case be used as a closure mechanism for the cover. The arrows indicate the rotation direction of the splicing cassette carrier 24 over the splicer 20.

In the folded closed state, a covering apparatus 62, which is arranged above the opening 30 for the splicing unit 10, is located within the cutout, which can already be seen in FIG. 1 and is bounded by the carrier arms 48 and the plate 56. The covering apparatus 62 for the splicing unit 10 can likewise be opened via a shaft 64, which is essentially parallel to the axis 54 for the splicing cassette carrier 24. In this embodiment, the covering apparatus is in the form of a covering flap. It is also possible for the covering apparatus to be moved laterally over the opening 30. The covering apparatus 62 can also be completely removed. It should be noted that the covering apparatus 62 and the splicing cassette carrier 24 are not impeded during their mutual movements about the axes, with the following exception:

A security apparatus 60 (see FIG. 1) comprising a projection ensures that the covering apparatus 62 for the splicing unit 10 cannot be opened when the splicing cassette carrier is in the covering position (FIG. 2). Thus, as an exception, in this specific example, the covering apparatus 62 cannot move past the projection of the security apparatus 60 of the splicing cassette carrier. A projection can likewise be provided for this purpose on the covering apparatus, and represents the corresponding opposing piece.

A cover 66, which covers the shrinking unit, is arranged behind the covering apparatus 62. A stop surface 70 is in each case located to the right and left of the cover 66, and these stop surfaces 70 define a fixed rotation position, operatively related to the carrier arms of the rotatable splicing cassette carrier 24. In this rotation position, the splicing cassette carrier 24 holds a splicing cassette 36 correctly (see FIG. 5). In this example, the splicing cassette carrier cannot be rotated beyond the stop surfaces 70.

FIG. 3 shows a similar perspective illustration of the splicer 20 as in FIG. 2, but with the splicing cassette carrier 24 folded open. In this position, the splicing cassette carrier 24 can be used as a handle or holder for the splicer 20. In this case, the hand of the person carrying the splicer is placed in the cutout, that is bounded by the carrier arms 48 and the plate 56, in order to hold the splicer 20 on the inner edge of the splicing cassette carrier 24.

The control and/or display area 26, which can now be seen freely in the folded-up state with a control area 26b and a display area 26a, for example a TFT display, can also clearly be seen. It is likewise possible to see the stop surfaces 72, which define a rotation position of the splicing cassette carrier 24 in which the latter is used as a cover for the control and/or display apparatus 26. It is possible to provide the stop surfaces 72 with a sealing rubber, in order to prevent the ingress of dust or moisture to the control area 26b or the display area 26a in the covered state.

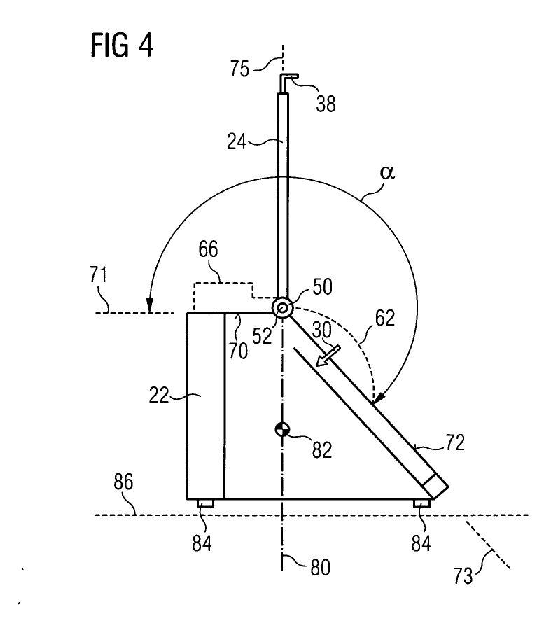

FIG. 4 shows a schematic illustration, in the form of a cross section from the side, of the situation shown in FIG. 3. The stop surfaces 72, 70 define an angle range α in which the splicing cassette carrier 24 can be rotated. The dashed lines in the extension of the stop surfaces indicate the corresponding rotation positions 71, 73 of the splicing cassette carrier 24. It is clear to a person skilled in the art in the field of splicing technology that elements other than stop surfaces 70, 72, for example projections, tabs, magnetic elements, etc. can also be used to limit the angle range α in order to define the cassette holding function and the covering function. The invention is not restricted to specific embodiments.

The splicing cassette carrier 24 is used as a handle or holder for the splicer 20 in a rotation position 75 in the middle within the range α. This exemplary embodiment provides for the center of gravity 82 of the splicer 20 to be arranged vertically below the rotation axis 54 or the shaft mounting 50, 52 when the splicer is placed on a flat surface 86. In the process of placing the splicer 20 down, the feet 84, which for example have an (elastic) damping function, meet this surface 86 at approximately the same time. This prevents shaking or sudden rotary movements.

FIG. 5 shows, in the form of a schematic side view, an exemplary embodiment in which the splicing cassette carrier 24 is used to hold the splicing cassette 36 correctly. The clamp 38 and stop pins 40 hold the splicing cassette 36, as described initially, in a clamped-in and a fixed state. The control and display apparatus 26 is arranged, for example, in an opening 32 in the chassis 22 of the splicer 20 and is connected to a control unit 34 by means of which the individual processes of splicing etc. are carried out. In order to control the splicing process, the control unit 34 is likewise connected to the splicing unit 10, which is accessible via the opening 30 when the covering apparatus 62 is open.

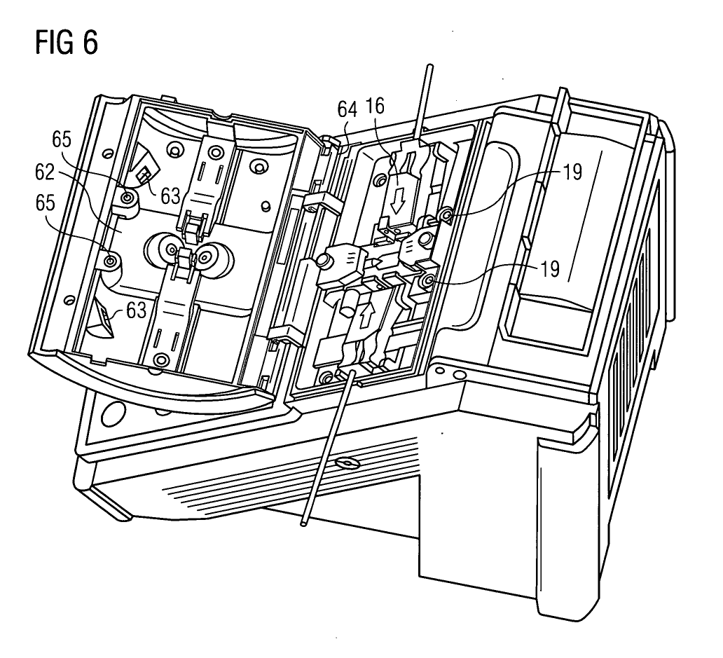

FIG. 6 shows a splicer with a covering apparatus 62 open. In this exemplary embodiment, the shaft 64 is arranged above the control and display apparatus 26. A lighting device 63 is provided in the covering apparatus 62. By way of example, the lighting device may be in the form of one or more light-emitting diodes. The lighting device 63 is arranged in the covering apparatus 62 such that the fiber holders 16 are illuminated when the lighting device is in an activated state.

Furthermore, the lighting device 63 is coupled to the control unit 34 such that the lighting device can be activated/deactivated by the control unit. In addition, the control unit 34 is also connected to a sensor unit 65. By way of example, the sensor unit 65 may be in the form of a Hall sensor. The Hall sensor 65 detects a magnetic field which is produced by a magnet 19 which is arranged at an upper edge of the opening 30. The opening and closing of the covering apparatus can therefore be detected by means of the Hall sensor detecting the magnetic field that is produced by the magnet 19. For this purpose, the sensor unit 65 produces an appropriate control signal, which is passed on to the control unit 34.

On opening of the covering apparatus 62, the control unit operates the lighting device 63 such that the lighting device is activated in order to illuminate the splicing unit and in particular the fiber holders. The brightness of the light emitted by the lighting device is preferably variable. In this type of embodiment, the brightness of the light emitted by the lighting device can be increased slowly, for example, on opening of the covering apparatus.

The lighting device is deactivated by the control unit on closing of the covering apparatus. The lighting device is preferably deactivated more quickly than its activation, in order not to interfere with a video/camera recording system for the splicing unit, by means of which the entire splicing process can be observed on the display apparatus 26.

A supply current for operating circuit components of the splicer, for example of the control and display apparatus 26 and of the splicing unit 10, is provided by a supply device 35. The supply device 35 provides the supply current for the circuit components via a controllable switch 33. For example, the controllable switch 33 is in the form of a relay-operated switch. In one embodiment of the splicer, it is closed (switched on) when the splicing cassette carrier 24 is opened and is therefore in the rotation position 71. When the splicing cassette carrier is closed and is located in the rotation position 73, the relay-operated switch is switched off. The splicer can therefore be switched on and off by means of the splicing cassette carrier 24. The splicer is switched on when the splicing cassette carrier 24 is moved from the position 73 to the position 71, and is switched on when the splicing cassette carrier 24 is in the position 71. On the other hand, the splicer is switched off when the splicing cassette carrier 24 is moved from the position 71 to the position 73, and is switched off when the splicing cassette carrier 24 is located in the position 73.

In another embodiment, the splicer can be operated in two different operating modes via the control unit 34, with the supply device providing a higher supply current for the circuit components in a normal operating mode and producing a lower supply current in a standby mode, since the circuit components, for example the display apparatus 26b, are in a rest state (sleep mode) in the standby mode. The control unit 34 operates the splicer in the normal operating mode or in the standby operating mode as a function of a rotation position of the splicing cassette carrier.

A sensor unit is provided in order to detect the rotation position that the splicing cassette carrier is in, and is connected to the control unit 34. In one embodiment of the sensor unit, a magnetic field is detected. For this purpose, a magnet 47 is located under the plate 56 in the splicing cassette carrier 24, as shown in FIG. 3. The magnetic field of the magnet 47 is detected by a Hall sensor 23 which, in the example in FIG. 3, is arranged under the control and display apparatus on the chassis 22. When the splicing cassette carrier is in the closed state, the Hall sensor detects a strong magnetic field. In this case, either the relay-operated switch 33 is opened, as a result of which the splicer is switched off, or the splicer is switched to the standby mode, in which the power consumption of the circuit components 10, 26, 28 and 34 is reduced. If the supply device is in the form of a rechargeable battery, this allows the operational readiness of the splicer to be lengthened. When the splicing cassette carrier is opened (rotation position 71), the splicer is once again operated in the normal operating mode by the control unit.

By way of example, the sensor unit may also be in the form of a brightness sensor 27 which, as shown in the exemplary embodiment in FIG. 3, is arranged on the control and display apparatus 26 and, when the splicing cassette carrier is in the closed state, is covered or masked by it. Furthermore, FIG. 3 shows a further embodiment of a sensor for detecting a rotation position of the splicing cassette carrier. For this purpose, a controllable switch 29 is arranged on at least one of the stop surfaces 72 of the chassis and, for example, is in the form of a contact pin. The contact pin is pushed down when the splicing cassette carrier is folded closed. The control unit then operates the splicer in the standby mode.

A further possibility to reduce the power consumption of the supply device 35 is to match the background lighting of the display apparatus 26a, which, for example, is in the form of a TFT display, to the environmental brightness when the splicing cassette carrier is open. By way of example, the brightness sensor 27 can likewise be used for this purpose. The light intensity of the background lighting of the display apparatus is increased or decreased appropriately as a function of the environmental brightness detected by the brightness sensor.

In one preferred embodiment, not just one brightness sensor is provided. Instead of this, further brightness sensors 27b and 27c are fitted to the side surfaces alongside the stop surfaces 72. This allows the background lighting of the display to be controlled as a function of direction. The background lighting of the display is controlled by the control unit 34 as a function of the brightness detected from different directions by the brightness sensors.

FIG. 5 also shows a simplified illustration, in the form of a sketch, of the steps in the splicing process. The configuration of the splicer is adjusted by means of the control and/or display apparatus 26. Once the splicing cassette carrier 24 and the covering apparatus 62 have been opened, the fiber holders 16 are opened, and the fibers 18 are inserted (see FIG. 6) in a first movement process 91. The splicing process is then started via the control apparatus. After the splicing process, the spliced fibers are removed (reference symbol 92), and are inserted into the shrinking unit 28. A shrink sleeve is shrunk onto the spliced fibers 18 there, under the influence of heat. The spliced and shrunk fibers are then removed, and the splicing cassette 31 is inserted (reference symbol 93).

Whilst all the fibers in a strip have been spliced or the cassette 36 has been filled, its content can first of all be processed and, if appropriate, the splicing process thus ended. The clamp 38 is released, the cassette 36 is removed, and the splicing cassette carrier 24 is once again folded back to the covering position shown in FIG. 2. This position prevents further contamination while the cable is being laid with the spliced fibers. If no further activities need to be carried out at that location, then the operator can fold the splicing cassette carrier 24 up again (to the position shown in FIG. 3) in order to carry the splicer 20 to a different location where it is intended to be used again or stored once the work has been finally completed.

We claim:

1. A splicing cassette carrier for holding a splicing cassette while splicing optical waveguides in a splicer, comprising:
a plate with a flat surface for holding the splicing cassette;
at least one carrier arm which is connected to the plate and supports it;
an apparatus by means of which the at least one carrier arm can be attached to a chassis of the splicer, mounted such that it can rotate about a rotation axis, such that the splicing cassette carrier can be pivoted about the rotation axis.

2. The splicing cassette carrier of claim 1, in which the apparatus has a bush which, as a bearing, is operatively connected to a shaft which is attached to the chassis, in order to make it possible for the at least one carrier arm and the plate to rotate about the rotation axis.

3. The splicing cassette carrier of claim 1, in which the apparatus has a shaft which is operatively connected to a bush which is in the form of a bearing and is arranged on the chassis, in order to make it possible for the at least one carrier arm and the plate to rotate about the rotation axis.

4. The splicing cassette carrier of claim 1, in which the plate has at least one stop element which projects out of the flat surface and by means of which a splicing cassette, which is placed on the surface of the plate, is fixed in a first direction parallel to the surface.

5. The splicing cassette carrier of claim 4, in which the plate has an adjustable clamp by means of which a splicing cassette which is placed on the surface is clamped in by mechanical pressure in a second direction parallel to the surface, with the second direction being opposite the first direction.

6. The splicing cassette carrier of claim 4, in which the at least one stop element is a pin, which is designed such that it can be removed from a hole in the plate.

7. The splicing cassette carrier of claim 6, in which a plurality of holes are provided in the plate in order to allow splicing cassettes of differently standardized widths to be accommodated.

8. The splicing cassette carrier of claim 1, in which the plate and the at least one carrier arm are formed integrally.

9. The splicing cassette carrier of claim 1, which has two carrier arms, which are both connected to the plate and each of which has an apparatus for rotatable mounting about a rotation axis on the chassis of the splicer.

10. The splicing cassette carrier of claim 1, in which the at least one carrier arm is made from plastic.

11. The splicing cassette carrier of claim 9, in which the two carrier arms are made from plastic and they are integrally connected to one another via a plastic element, and in which the plate is made from metal and is attached to the plastic element.

12. The splicing cassette carrier of claim 3, in which the shaft is formed by a threaded screw which can be accommodated by the bush which is fitted to the chassis.

13. A splicer, comprising:
a chassis with an opening and an apparatus for rotatable mounting of the splicing cassette carrier of claim 1,
a splicing unit for splicing of optical waveguides, with the splicing unit being arranged in the opening,
a control apparatus for inputting control commands in order to operate the splicer and/or a display apparatus for indicating the input control commands, which display apparatus is arranged in or on the chassis,
the splicing cassette carrier, which is mounted rotatably on the chassis by means of the apparatus, such that it can assume a first rotation position, in which it is used to hold a splicing cassette, and at least one second rotation position, in which it acts as a protective cover for the control and/or display apparatus.

14. The splicer of claim 13, in which stop surfaces are in each case provided on the chassis for the first and the second rotation position and each respectively prevent the splicing cassette carrier from being rotated beyond the first and the second rotation positions.

15. The splicer of claim 13, in which a permissible angle rotation range (α) within which a third rotation position is located is limited by an arrangement of the stop surfaces relative to the rotation axis for rotating the splicing cassette carrier, such that the splicer is freely aligned on the basis of the position of its center of gravity relative to the rotation axis when the splicing cassette carrier is used as a carrying handle.

16. The splicer of claim 13, in which the splicing cassette carrier can be latched in the first, second and/or third rotation position by mechanical, electromechanical or electromagnetic elements.

17. The splicer of claim 13, in which the adjustable clamp for exerting pressure on a splicing cassette which has been placed on the splicing cassette carrier in the first rotation position is also designed to lock the splicing cassette carrier in the second rotation position in order to close the control and display apparatus securely.

18. The splicer of claim 15, in which the rotation axis for rotating the splicing cassette carrier is arranged vertically over the center of gravity of the splicer, in order to prevent any sudden tilting movement of the splicer during raising or lowering with the aid of the splicing cassette carrier as a carrying handle on a flat base surface.

19. The splicer of claim 13, in which the opening has a covering apparatus for accommodating the splicing unit and in which the carrier arm or arms of the splicing cassette carrier and its plate surround a cutout such that the covering apparatus for the opening is positioned in the cutout for accommodating the splicing unit at the second rotation position at which the control and/or display apparatus is covered without colliding with the splicing cassette carrier during a rotary movement of the splicing cassette carrier.

20. The splicer of claim 19, in which the splicing cassette carrier has a security apparatus such that the cover cannot be opened while the splicing cassette carrier is fixed in the second rotation position.

21. The splicer of claim 13, comprising:
a control unit for controlling a splicing process, which control unit is connected to the control and/or display apparatus and to the splicing unit.

22. The splicer of claim 21,
having a supply device for providing a supply current for operating circuit components of the splicer,
in which case the splicer can be operated in a first or a second operating mode, with a lower supply current being provided by the supply device in the first operating mode than in the second operating mode,
in which the control unit is designed such that it operates the splicer as a function of the rotation position of the splicing cassette carrier in the first or second operating mode.

23. The splicer of claim 22,
in which the control unit operates the splicer in the first operating mode when the splicing cassette carrier assumes the first rotation position and operates the splicer in the second operating mode when the splicing cassette carrier assumes the second rotation position.

24. The splicer of claim 13,
having a supply device for providing a supply current for operating circuit components of the splicer,
having a controllable switch via which the supply device provides the supply current for the circuit components when the controllable switch is switched on,
in which the controllable switch is switched on or off as a function of the rotation position of the splicing cassette carrier.

25. The splicer of claim 24,
in which the controllable switch is in the form of a relay-operated switch.

26. The splicer of claim 13,
with the splicer being switched on or off as a function of the rotation position of the splicing cassette carrier.

27. The splicer of claim 21, further including a first sensor unit for detecting a state of the rotation positions of the splicing cassette carrier, which first sensor unit is connected to the control unit.

28. The splicer of claim 27,
in which the first sensor unit comprises a magnet which is arranged on the splicing cassette carrier, and a Hall sensor which is arranged on the chassis, in order to detect a magnetic field of the magnet.

29. The splicer of claim 27, in which the first sensor unit comprises a brightness sensor which is arranged on the control and/or display apparatus such that it is covered by the splicing cassette carrier when the splicing cassette carrier is in the second rotation position.

30. The splicer of claim 27, in which the first sensor unit comprises an activatable switch which is arranged on the chassis such that it can be activated as a function of a rotation position of the splicing cassette carrier.

31. The splicer of claim 13, in which the display apparatus has background lighting, the light intensity of which is variable.

32. The splicer of claim 31,
having a brightness sensor for detecting environmental brightness of the splicer,
in which the control unit controls the display apparatus such that the light intensity of the background lighting is set as a function of the environmental brightness detected by the brightness sensor.

33. The splicer of claim 32,
having further brightness sensors with the brightness sensor and the further brightness sensors being arranged on different side surfaces of the chassis, such that the environmental brightness can be detected by the brightness sensors as a function of direction,
in which the control unit controls the display apparatus such that the light intensity of the background lighting is set as a function of direction, and depending on detected environmental brightness.

34. The splicer of claim 19,
having a lighting device for producing light, which lighting device can be activated/deactivated by the control unit,
in which the control unit is designed such that it activates the lighting device when the covering apparatus is opened, and deactivates the lighting device when the covering apparatus is closed.

35. The splicer of claim 34,
in which the brightness of the light which is produced by the lighting device is variable,
in which the control unit operates the lighting device such that the brightness of the light which is produced by the lighting device is increased after the covering apparatus has been opened.

36. The splicer of claim 35,
in which the control unit operates the lighting device such that the lighting device is deactivated more quickly on closing the covering apparatus than the brightness of the lighting device is increased once the covering apparatus has been opened.

37. The splicer of claim 27, having a second sensor unit for detecting a state of the covering apparatus, which second sensor unit is connected to the control unit.

38. The splicer of claim 37,
in which the second sensor unit comprises a magnet and a Hall sensor for detecting a magnetic field of the magnet.

39. The splicer of claim 33,
in which the splicing unit comprises a fiber holder into which at least one optical fiber can be inserted,
in which the lighting device is arranged in the covering apparatus such that, in the activated state, it illuminates the fiber holder.

40. The splicer of claim 33,
in which the lighting device is in the form of a light-emitting diode.
